(19) United States
(12) Patent Application Publication
(10) Pub. No.: US 2021/0038929 A1
(43) Pub. Date: Feb. 11, 2021

(54) HARNESS FOR ATTACHMENT TO A PERSON TO BE SECURED HAVING A BELAY LOOP

(71) Applicant: SKYLOTEC GmbH, Neuwied (DE)

(72) Inventors: Philipp Vitt, Koblenz (DE); Heidi Bamberger, Torney (DE)

(21) Appl. No.: 16/985,507

(22) Filed: Aug. 5, 2020

(30) Foreign Application Priority Data
Aug. 6, 2019 (DE) 10 2019 121 171.9

(51) Int. Cl. A62B 35/00; F16G 11/00

(52) U.S. Cl. CPC A62B 35/0018; A62B 35/0025; F16G 11/00

(57) ABSTRACT

The subject matter of the invention is a harness for attachment to a person to be secured, in particular a climbing harness or personal protective equipment, having a hip belt, a leg belt, and a belay loop, wherein
the hip belt and/or the leg belt each have an eyelet on both sides,
the belay loop has at each of its end areas a rectangular buckle and a triglide, and
the belay loop is guided at its respective end areas through the respective triglide, the respective end of the belay loop is guided through the respective rectangular buckle, and is connected to the respective end area of the belay loop, so that the respective triglide and rectangular buckle are arranged spaced apart from one another, and by guiding the respective triglide initially through the respective eyelet and subsequently through the respective rectangular buckle, the respective end area of the belay loop is fixable at the respective eyelet.

### PRIORITY CLAIM

This application is related and claims priority to DE 10 2019 121 171.9, filed on Aug. 6, 2019, which is incorporated by reference herein in its entirety.

### TECHNICAL AREA

The invention relates to a harness for attachment to a person to be secured, in particular a climbing harness or personal protective equipment, comprising a hip belt, a leg belt, and a belay loop, wherein the hip belt and/or the leg belt each have an eyelet on both sides. The invention further relates to a method for fixing a belay loop to a harness for attachment to a person to be secured, in particular a climbing harness or personal protective equipment, wherein the harness has a hip belt, a leg belt, and the belay loop, and the hip belt and/or the leg belt each have an eyelet on both sides.

### BACKGROUND OF THE INVENTION

A part of safety equipment is designated as a harness, which is worn on the body during tree maintenance, climbing, mountaineering, via ferrata, or during work with a risk of falling, and through which a connection is established between the person to be secured and a safety device to prevent falls or a tie in point. The harness is generally made from several loops, which are placed around the middle of the body as the hip belt and around the legs as the leg belt. The loops are brought together at a tie in point, to which a safety rope or a carabiner may be connected as a safety device against falling. The hip belt, the leg belt, and the optionally present chest strap are adjustable to the bodily dimensions of the person to be secured, so that on the one hand forces occurring between the person and the harness are safely transmitted and, on the other hand, it may be prevented that the person to be secured unintentionally slips out of the harness. Harnesses for climbing in the recreation sector and for industrial safety are basically comparable in structure; however, they must satisfy different standards. While the standard EN 12277 is relevant, for example, in the sporting sector, the standard EN 361 applies for harnesses for industrial safety and standard EN 358 applies for tethers.

The leg loops of the leg belt of a harness configured for tree maintenance are generally connected via a belay loop or a rope connection, at which, for example, the tie in point is provided configured as a tie in ring. The tie in ring may slide in such a way between ends of the belay loop so that a tree maintenance worker secured with the harness may adopt different positions relative to the tree, without having to change the safety device. However, the sliding results in increased wear, so that the belay loop must be regularly replaced.

Belay loops known from the prior art have at their ends knottable ropes or screwable eyelets, which are able to be connected to the leg belt. Since tree maintenance personnel regularly change the belay loops themselves, it is not always ensured that the ropes are correctly knotted or that the screws are tightened sufficiently. In addition, knotting the rope or unscrewing or screwing in is a manual, and often very awkward activity that demands a lot of time. The belay loops known from the prior art, even if technically unchanged in principle for decades, are thus not ideal with respect to safety and handling.

### BRIEF DESCRIPTION OF THE INVENTION

Arising from this situation, it is an object of the invention to specify a harness with a replaceable belay loop, whose belay loop is able to be substantially easier and simultaneously safer to replace.

The object of the invention is solved by the features of the independent claims. Advantageous embodiments are indicated in the subclaims.

Accordingly, the problem is solved by a harness for attachment to a person to be secured, in particular a climbing harness or personal protective equipment, having a hip belt, a leg belt, and a belay loop, wherein
the hip belt and/or the leg belt each have an eyelet on both sides,
the belay loop has at each of its end areas a rectangular buckle and a triglide, and
the belay loop is guided at its respective end areas through the respective triglide, the respective end of the belay loop is guided through the respective rectangular buckle, and is connected to the respective end area of the belay loop, so that the respective triglide and rectangular buckle are arranged spaced apart from one another, and by guiding the respective triglide initially through the respective eyelet and subsequently through the respective rectangular buckle, the respective end area of the belay loop is fixable at the respective eyelet, in particular by clamping the triglide on the rectangular buckle.

One essential aspect of the proposed harness is that the belay loop is, in particular, easier to replace and on the other hand is replaceable in a particularly safe way, in contrast to solutions known from the prior art. For solutions known from the prior art, the end areas of the belay loop are generally knotted to the harness or screwed on by means of eyelets. The unscrewing and screwing in is substantially more time-consuming and additionally less secure, since when using the harness, screws that are not correctly tightened loosen and in such a way that a person secured with the harness or the belay loop may fall. This applies analogously for knotted connections.

In the proposed solution, the triglide of the belay loop is guided through the eyelet and then through the rectangular buckle, so that the end area of the belay loop is fixed at the eyelet, in particular after clamping the triglide to the rectangular buckle. Clamping means, in particular, that the triglide lies on the rectangular buckle, in particular lies in a contacting way, so that the end area connected to the triglide is fixed with respect to the rectangular buckle. To release the end area from the belay loop, the triglide is initially guided out of the rectangular buckle and then out of the eyelet.

The rectangular buckle preferably has one single rectangular opening, while the triglide has two rectangular openings separated by the web. The rectangular buckle and triglide preferably have a rectangular shape, which corresponds in particular with respect to their longitudinal and/or transverse extension. Thus, when the triglide lies with its longitudinal side parallel or approximately parallel to the longitudinal side of the rectangular buckle, the triglide may not ‘slip through’ the opening of the rectangular buckle, and is thus secured against loosening by the rectangular buckle. The web of the triglide preferably extends parallel to the longitudinal side of the triglide. The guiding through is preferably carried out by pivoting the triglide in such a way that the triglide is guided, with its transverse side in front, through the opening of the rectangular buckle and likewise through the eyelet. The clamping is carried preferably out by aligning the triglide, that has been guided through, in such a way that the triglide comes to lie with its longitudinal side parallel or approximately parallel to the longitudinal side of the rectangular buckle, thus, the triglide may not ‘slip through’ the opening of the rectangular buckle and is secured in such a way against loosing.

The belay loop, also called a rope bridge, is preferably guided, with its end in front, initially around the web of the triglide and is guided in such a way through both openings of the triglide so as to form a first loop. From the first loop, the strap of the belay loop runs back preferably in parallel, and is guided with its end through the rectangular buckle, preferably forming a second loop. Finally, the end is connected to the strap of the end area so that the triglide and rectangular buckle, spaced apart from one another at the two loops, are connected to the belay loop and are held in such a way. A tying in point, in the form of a tie in point, described farther below, is provided between the end areas.

The hip belt and/or the leg belt may be designed as is known from the prior art, for example, it/they may have padding, which surrounds the supporting binding straps and/or is surrounded by the supporting binding straps. In addition, material carry loops and/or adjustment buckles may be provided on the hip belt, which is also designated in the prior art as the waist belt or lumbar part. The hip belt and/or the leg belt additionally preferably comprise one or more belt straps, previously mentioned binding straps, individual cords, or a combination of the previously mentioned straps or cords. The padding provided on the hip belt and/or on the leg belt may be configured from a breathable material in order to increase the wearing comfort of the harness, for example, made from a knitted spacer fabric, spacer fabric, spacer mesh and/or a net-like padding. In addition, the padding may have its own lateral stiffness and/or lateral stiffness at some points, so that the hip belt or leg belt remains dimensionally stable under load or tension.

While it is basically possible that the padding takes on a supporting function, the binding straps running across the padding preferably receive the forces and simultaneously function as support straps. The padding preferably has a thickness of less than 30 mm, preferably 20 mm. Straps made from high-strength, synthetic materials, like polyethylene or polyamide are used as straps, in particular as binding straps or support straps for the hip belt and/or for the leg belt or the leg loops and/or for the belay loop, and have a width of ≥20 mm and ≤50 mm and/or are configured as wide/narrow fabrics, subsequently called wide/narrow straps. The tie in point is preferably configured so that a rope, a carabiner, a sliding lock or the like is connectable to the same.

There exist various possibilities for configuring the eyelets. In one preferred refinement, the eyelets are configured as eyelets with webs, as triglides, or as D-rings with respective webs. The eyelets preferably have two openings separated by the web, wherein straps of the hip belt and/or of the leg belt are guided through the rear opening and the end area of the belay loop is guidable through the front opening.

According to another preferred refinement, the leg belt has a leg loop on both sides respectively and the eyelets are provided on one leg loop in each case and/or on a right and left front side of the harness. The eyelets are preferably provided on lateral sides of the harness, in particular, when the harness is worn, are provided on a front right and left lateral side or the hips of the person wearing the harness.

According to another preferred embodiment, the respective end of the belay loop is sewn to the respective end area of the belay loop in such a way that the end is enclosed between two sections of the end area. The seam fixes in this way three strap layers of the belay loop, namely, the two loops enclosing the rectangular buckle and the triglide respectively. The seam may extend between the rectangular buckle and the triglide in order to fix the rectangular buckle and triglide in their position relative to the belay loop in this way. The seam is preferably arranged adjacent to the rectangular buckle, wherein the loop enclosing the rectangular buckle is smaller than the loop enclosing the triglide, in order to moveably fix the triglide in this way with respect to the rectangular buckle.

In another preferred embodiment, the belay loop is interwoven between the end areas and forms a circular cross section. The harness or its straps preferably has/have at last partially a wide/narrow strap with a wide/narrow cross section, which transitions at the belay loop between the end areas into the round cross section or is woven with a round cross section. In one preferred refinement, the belay loop is interwoven and/or sewn to one another in an entire connection area between the end areas. Due to the sewing, the friction between the belay loop and the tie in point is reduced during displacement of the same against one another. Since the belay loop is the most highly loaded point of the harness, the wear at this point is reduced by the sewing, which results in an increased lifespan of the harness and/or the belay loop. The belay loop preferably has a round cross section between the end areas, in particular with a diameter ≥4 mm and ≤8 mm. In another particularly preferred embodiment, the belay loop is woven from at least one continuous thread. By using a continuous thread, a particularly high stability is achieved and a simple production is facilitated on the other hand.

According to one preferred refinement, the belay loop is designed between the end areas from a core thread and a wear-resistant layer surrounding the core thread, and the wear-resistant layer is designed to change its color and/or the color intensity of its color with ongoing use of the belay loop as an indicator for the wear of the belay loop, and/or the core thread is formed from a material which has a different color and/or a different color intensity of the color with respect to the wear-resistant layer. When using the harness, it is generally the case that the belay loop chafes at the tie in point and/or at a belaying ring or the like. This wears off the wear-resistant layer and the differently colored core thread, previously covered by the wear-resistant layer, emerges. The person using the harness recognizes in an easy and advantageous way due to the color change, that the belay loop should be replaced to maintain safety levels, even if the core thread, and optionally a part of the wear-resistant layer, securely connect the harness to the tie in point. Due to the wear-resistant layer surrounding the core thread, preferably completely, an objective possibility is thus created for recognizing wear of the belay loop in a reliable way. The core thread and/or the wear-resistant layer are preferably made from high-strength synthetic materials, like polyester or polyamide, for example, Dyneema. A plurality of core threads interwoven with one another is particularly preferably provided, wherein the wear-resistant layer is likewise designed from threads interwoven with one another. The wear-resistant layer preferably surrounds the entire casing surface of the core thread. Even more preferably, the wear-resistant layer surrounds the core thread in such a way that, in a side view, the thickness of the wear-resistant layer is ≤5%, ≤10%, or ≤20% of the diameter of the core thread.

According to another advantageous embodiment, the belay loop has two or a plurality of tie in points, which are arranged between the end areas and are connected to the belay loop. Various possibilities basically exist for configuring the tie in point. The tie in point is particularly preferably configured as a tying in loop, through which the belay loop is guided. Likewise, the tie in point may be configured as a belaying ring or a belaying eyelet, in particular consisting of metal. The belay loop is preferably guided through the tying in loop so that the tying in loop may slide on the belay loop between the end areas or between the rectangular buckles. A carabiner or the like may preferably be latched into the tie in point, by means of which carabiner the person secured with the harness may be connected to a fall arrester or the like for securing against falling.

In another preferred embodiment, the respective rectangular buckle and triglide are arranged spaced apart from one another by at least 5 cm or 10 cm. The triglide is preferably more flexibly fixed in its position that the rectangular buckle. For example, the triglide may be arranged to be moveable within limits relative to the rectangular buckle so that the distance between the rectangular buckle and the triglide may be between 5 cm and 10 cm.

The problem is additionally solved by a method for fixing a belay loop on a harness for attachment to a person to be secured, in particular a climbing harness or personal protective equipment, wherein
the harness has a hip belt, a leg belt, and the belay loop,
the hip belt and/or the leg belt each have an eyelet on both sides,
the belay loop has a rectangular buckle and a triglide on its respective end areas, and the belay loop is guided at its respective end areas through the respective triglide, the respective end of the belay loop is guided through the respective rectangular buckle, and is connected to the respective end area of the belay loop, so that the respective triglide and rectangular buckle are arranged spaced apart from one another, comprising the step:
guiding the respective triglide initially through the respective eyelet and subsequently through the respective rectangular buckle for fixing the respective end area of the belay loop at the respective eyelet.

The described method enables the replacement of a worn belay loop in a particularly simple way, wherein the belay loop to be substituted in is able to be securely connected to the harness in a likewise simple way.

According to one preferred refinement of the method, the leg belt has a leg loop on both sides respectively and the eyelets are provided on one leg loop in each case and/or on a right and left front side of the harness.

Additional advantageous embodiments and advantages of the method arise for the person skilled in the art analogously to the previously described harness.

### BRIEF DESCRIPTION OF THE DRAWINGS

The present invention is described below in greater detail on the basis of a preferred exemplary embodiment with reference to the appended drawings.

As shown in the drawings:

FIG. 1 a harness with a belay loop according to one preferred exemplary embodiment in a schematic view,

FIG. 2 a section of the harness according to FIG. 1 during fixing of the belay loop to a leg belt of the harness in a schematic view,

FIG. 3 the section of the harness according to FIG. 1 with the belay loop fixed to a leg belt in a schematic view,

FIG. 4 the belay loop of the harness according to FIG. 1 in a schematic view,

FIG. 5 an end area of the belay loop according to FIG. 4 in a schematic view, and

FIG. 6 the end area of the belay loop according to FIG. 5 in another schematic view.

### DETAILED DESCRIPTION OF THE EXEMPLARY EMBODIMENTS

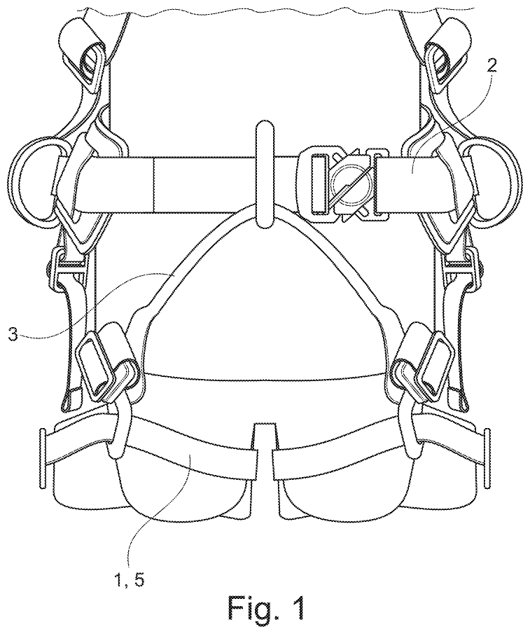

FIG. 1 shows a harness for attachment to a person to be secured according to a preferred exemplary embodiment in a schematic view. The harness, which is usable in particular for tree maintenance both in private and also industrial sectors as part of a personal protective equipment, has a hip belt 2, a leg belt 1, and a belay loop 3.

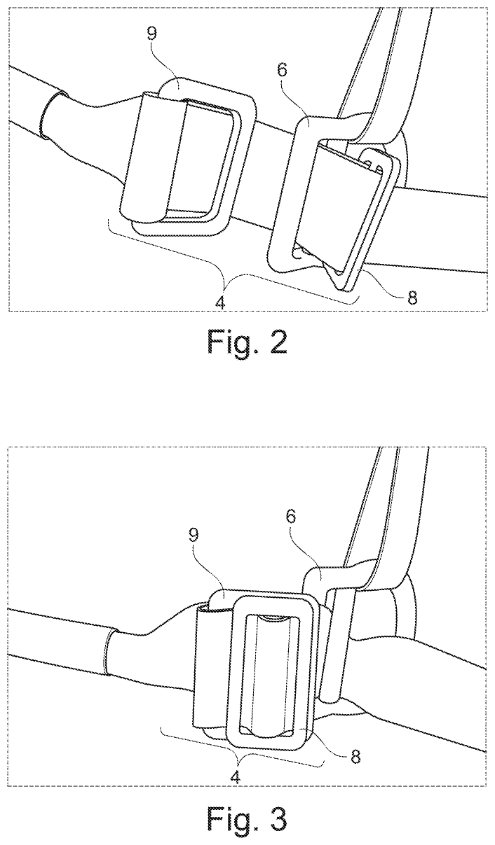

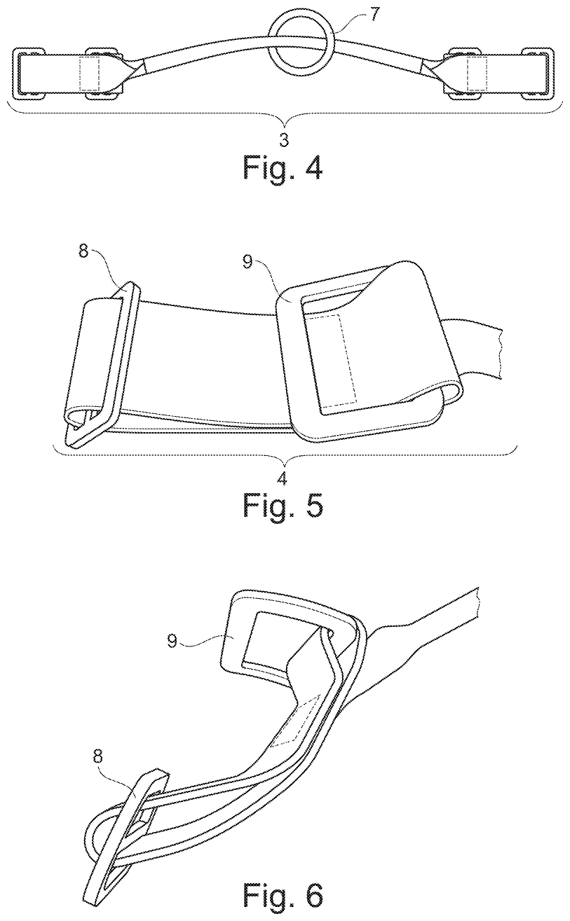

FIG. 2 shows a section of the harness according to FIG. 1 during the fixing of belay loop 3 to leg belt 1, while FIG. 3 shows the section with belay loop 3 fixed on leg belt 1 in respective schematic views. In FIG. 4, belay loop 3 of the harness according to FIG. 1 is shown in a schematic view, while FIGS. 5 and 6 respectively show an end area 4 of belay loop 3 according to FIG. 4 in schematic views.

Leg belt 1 has two leg loops 5, to which hip belt 2, arranged above with respect to leg belt 1 in the figures, is fixed by means of two connection bands extending vertically and provided on the two lateral sides of the harness in the figure. A chest strap is provided above hip belt 2 and connected to the same, and is fixed to the hip belt on both sides at the lateral sides of the person. Material carry loops are likewise arranged on the lateral sides on both sides on hip belt 2. Hip belt 2, leg belt 1, chest strap, and belay loop 3 are configured from straps made from a high-strength synthetic material, like polyester or polyamide and have a wide/narrow cross section. Hip belt 2, leg belt 1 or leg loops 5, and the chest strap additionally have an internal padding.

An eyelet 6 is provided on both sides on the lateral sides on leg belt 1 in front on the right and left respectively, which eyelet is designed as a D-ring eyelet with a web and correspondingly two openings, as is clear from FIG. 2. Straps of leg loop 5 and of hip belt 2 are guided through the opening depicted on the right in FIG. 2, while the front opening functions for fastening a respective end area 4 of belay loop 3, as is subsequently described. Belay loop 3 extends between two eyelets 6 across the longitudinal side of the harness or at the hips of the person secured with the harness across a length of approximately 30 cm. Since end areas 4 are sewn together, as is subsequently described, the entire length of belay loop 3, constructed from a wide/narrow band, is approximately 50 cm. In principle, belay loop 3 may be available in different lengths, depending on the size of the person and/or the intended use.

Between the two opposite end areas 4, belay loop 3 is guided through one or two metal tie in points 7—only one single tie in point 7 is shown in the figures—as a tying in loop, to which a carabiner or the like is able to be latched on, by means of which the person secured with the harness is connectable to a fall arrester or the like for securing against falling. The wide/narrow band of belay loop 3 is woven together, forming a circular cross section between the two opposite end areas 4.

Furthermore, belay loop 3 is constructed between end areas 4 from a core thread and a wear-resistant layer surrounding the core thread. The wear-resistant layer changes its color and the color intensity of its color with ongoing use of belay loop 3 as an indicator for the wear of belay loop 3. In addition, the core thread is formed from a material which has a different color and a different color intensity of the color in contrast to the wear-resistant layer, so that the wear is easy to detect.

Belay loop 3 has at each of its end areas 4 a rectangular buckle 9 and a triglide 8. At each end area 4, a respective end of the strap of belay loop 3 is initially guided through the first opening of triglide 9, around the web of triglide 9, and through the second opening of triglide 9 in a semi-circular loop, when viewed from the side. The end then runs back for approximately 10 cm parallel to the strap extending in the direction toward the middle of belay loop 3, is guided through rectangular buckle 8 in a semi-circular loop, when viewed from the side, and runs back a bit again in the direction of triglide 9.

The end of the strap is sewn to end area 4 of belay loop 3, extending up to triglide 9 and back from triglide 9 to rectangular buckle 8, in such a way that the end is enclosed in the center between these two sections of end area 4. Triglide 9 and rectangular buckle 8 are fixed in such a way on belay loop 3 and arranged spaced approximately 5 to 10 cm apart from one another. The seam is arranged adjacent to rectangular buckle 8 so that the loop enclosing rectangular buckle 8 is smaller than the loop enclosing the web of triglide 9.

By guiding a respective triglide 8 of belay loop 3 initially through the respective eyelet 6 of the harness, see FIG. 2, and subsequently, after forming a semi-circular loop, through respective rectangular buckle 9 of belay loop 3, see FIG. 3, respective end area 4 of belay loop 3 is fixed at respective eyelet 6 in a simple way and is loosened again in a likewise simple way in order to replace a worn belay loop 3. For guiding through, triglide 8 is guided, with its lateral side in front, through eyelet 6 and then, forming a loop, through rectangular buckle 9, and is finally pivoted with respect to rectangular buckle 9 so that triglide 8 comes to lie on rectangular buckle 9 in such a way that the respective lateral and longitudinal sides come to lie parallel or approximately parallel to one another, see FIG. 3. In this position, triglide 8 is fixed or clamped by rectangular buckle 9 so that the loop of belay loop 3 guided through triglide 8 is connected to the same.

The exemplary embodiments described are merely examples, which may be modified and/or supplemented in diverse ways within the scope of the claims. Each feature, which has been described for a specific exemplary embodiment, may be used independently or in combination with other features in a random different exemplary embodiment. Each feature, which has been described for an exemplary embodiment of a specific category, may also be used in a corresponding way in an exemplary embodiment from another category.

### LIST OF REFERENCE NUMERALS

Leg belt 1

Hip belt 2

Belay loop 3

End area 4

Leg loops 5

Eyelet 6

Tying in point 7

Triglide 8

Frame clasp 9

1-10. (canceled)

11. A harness for attachment to a person to be secured, having a hip belt, a leg belt, and a belay loop, wherein
the hip belt and/or the leg belt each have an eyelet on both sides,
the belay loop has at each of its end areas a rectangular buckle and a triglide, and
the belay loop is guided at its respective end areas through the respective triglide, the respective end of the belay loop is guided through the respective rectangular buckle, and is connected to the respective end area of the belay loop, so that the respective triglide and rectangular buckle are arranged spaced apart from one another, and by guiding the respective triglide initially through the respective eyelet and subsequently through the respective rectangular buckle, the respective end area of the belay loop is fixable at the respective eyelet.

12. The harness according to claim 11, wherein the eyelets are designed as eyelets with a web, as triglides, or as D-rings with a respective web.

13. The harness according to claim 11, wherein the leg belt has a leg loop on both respective sides and the eyelets are provided in each case on one leg loop and/or respectively on a right and left front side of the harness.

14. The harness according to claim 11, wherein the respective end of the belay loop is sewn to the respective end area of the belay loop in such a way that the end is enclosed between two sections of the end area.

15. The harness according to claim 11, wherein the belay loop forms a circular cross section woven together between the end areas.

16. The harness according to claim 11, wherein the belay loop between the end areas is designed from a core thread and a wear-resistant layer surrounding the core thread, and the wear-resistant layer is equipped to change its color and/or the color intensity of its color with ongoing use of the belay loop as an indicator for the wear of the belay loop, and/or the core thread is formed from a material which has a different color and/or a different color intensity of the color with respect to the wear-resistant layer.

17. The harness according to claim 11, wherein the belay loop has a tie in point which is arranged between the end areas and is connected to the belay loop.

18. The harness according to claim 11, wherein the respective rectangular buckle and triglide are spaced at least 5 cm or 10 cm apart from one another.

19. The harness according to claim 11, wherein the harness is provided as a climbing harness or as a personal protective equipment.

20. A method for fixing a belay loop on a harness for attachment to a person to be secured, wherein
the harness has a hip belt, a leg belt, and the belay loop,
the hip belt and/or the leg belt each have an eyelet on both sides,
the belay loop has a rectangular buckle and a triglide respectively on its end areas, and the belay loop is guided at its respective end areas through the respective triglide, the respective end of the belay loop is guided through the respective rectangular buckle, and is connected to the respective end area of the belay loop, so that the respective triglide and rectangular buckle are arranged spaced apart from one another, comprising the step:
guiding the respective triglide initially through the respective eyelet and subsequently through the respective rectangular buckle for fixing the respective end area of the belay loop at the respective eyelet.

21. The method according to claim 20, wherein the leg belt has a leg loop on both sides respectively and the eyelets are provided on one leg loop in each case and/or respectively on a right and left front side of the harness.

22. The method according to claim 20, wherein the harness is provided as a climbing harness or as a personal protective equipment.
